(19) United States
(12) Patent Application Publication
(10) Pub. No.: US 2008/0151782 A1
(43) Pub. Date: Jun. 26, 2008

(54) Method For Evaluating a Object By the Relation Among Links in the Information Network Having a Multi Link

(75) Inventor: Jhung Soo Hong, Paju (KR)

Correspondence Address: RABIN & Berdo, PC, 1101 14TH STREET, NW, SUITE 500, WASHINGTON, DC, 20005, US

(73) Assignee: SK Communications Corp., Seoul (KR)

(21) Appl. No.: 11/911,523

(22) PCT Filed: Apr. 14, 2006
(86) PCT No.: PCT/KR06/01389

§ 371 Date: Oct. 12, 2007

(30) Foreign Application Priority Data
Apr. 14, 2005 (KR) 10-2005-0031125

(51) Int. Cl. H04L 12/28

(52) U.S. Cl. 370/254

(57) ABSTRACT

Disclosed is a method for evaluating an object based on a relation among links in an information network forming multiple links by linking one or more upper nodes to a lower node, wherein importance information link indexes of the one or more upper nodes are determined according to upper nodes that are different from the one or more upper nodes and link to the lower node later than the one or more upper nodes.

### TECHNICAL FIELD

This invention relates to a method for analyzing a link structure, and more particularly, a method for evaluating an object based on a relation among links in an information network having multiple links.

### BACKGROUND ART

In general, when a user makes a search for a web page in a web site or the like, whether a found web page is good or bad depends on subjective judgment of the user. That is, since the evaluation on quality of a search result is extremely subjective, there is a need of an objective standard excluding a human's subjective judgment in judging a relation of the search result with a search word. Further, there is a need for a formularized method of implementing search quality with an algorithm.

As is generally known, web pages have a number of links interconnecting enormous information on web. Analyzing and evaluating interrelation among the links are meaningful in judging value of the information.

As one example of general link analysis methods, there is a ‘Kleinberg's Algorithm.’ This method defines authority and hubness and analyzes links based on the defined authority and hubness.

Hereinafter, concept of the conventional Kleinberg link analysis method will be described with reference to FIG. 1.

Referring to FIG. 1, it is assumed that node 2 120, node 3 130 and node 4 140 link to node 1 110 simultaneously. In this case, the linked node 1 110 becomes a lower node and the linking nodes 2 120, 3 130 and 4 140 become an upper node. Here, it can be seen that the more upper nodes linking to a particular lower node (for example, node 1 110), the higher importance level it becomes very likely to have.

In analyzing the links, the importance level of the lower node may be expressed by ‘authority’, and authority of the lower node may be decided with the number of upper nodes linking to the lower node and an importance information link level of the upper nodes. Here, when the importance information link level of the upper nodes is defined as ‘hubness of the upper nodes, authority of node 1 may be expressed by the sum of hubnesses of the upper nodes. That is, the authority of node 1 may be expressed as the following Equation 1.

a(1)=h(2)+h(3)+h(4) [Equation 1]

where, a(1) represents authority of node 1 and h( ) represents hubnesses of nodes 2, 3 and 4. In generalization, authority may be calculated according to an iterative algorithm expressed by the following equation 2.

$$a ( v ) ← {\sum }_{w ∈ uppernode [ v ]}^{ } h ( w ) \qquad [ Equation 2 ]$$

As another example, as shown in the left of FIG. 1, it may be assumed that node 1 110 links to node 5 150, node 6 160 and node 7 170. In this case, the linking node 1 110 becomes an upper node and the linked nodes 5 150, 6 160 and 7 170 become a lower node.

In this case, a node linking to nodes with high authority related to a subject is referred to as a hub in the sense that it plays a role of a central axis. As mentioned above, when the importance information link level of the hub is defined as ‘hubness, hubness of node 1 may be expressed by the sum of hubnesses of the lower nodes. That is, the authority of node 1 may be expressed as the following Equation 3.

h(1)=a(2)+a(3)+a(4) [Equation 3]

This equation may be generalized as the following equation 4,

$$h ( v ) ← {\sum }_{w ∈ lowernode [ v ]}^{ } a ( w ) \qquad [ Equation 4 ]$$

According to the above-described Kleinberg link analysis method, it can be seen that nodes with high authority are linked by many hubs. The more hub a node is linked by, the higher authority the node has. In addition, the more nodes having high authority a node links to, the higher hubness it has. This shows that hubness and authority have a mutually reinforcing relationship.

Accordingly, nodes with high authority may be obtained when nodes (i.e., hubs) with high hubness are found, and the nodes with high hubness may be found through the nodes with high authority. In general search websites, web pages with high hubness and high authority may be considered to be especially good web pages among search results for a global query.

As another link analysis method, there is a page rank analysis method employed in a search site ‘Google.’ This method defines importance level of each node as a “rank.” In this method, only ranks of upper nodes are considered, and lower nodes have high ranks in proportional to the ranks of the upper nodes. On the other hand, the ranks of the upper nodes are distributed to the lower nodes, and accordingly, the more the upper nodes have lower nodes, the lower rank the lower nodes have.

FIG. 2 is a view showing concept of the conventional page rank analysis method. Referring to FIG. 2, node 2 220 links to node 1 210 as a lower node, node 4 240 and node 5 250 link to node 3 230 as a lower node, and node 3 230 links to node 1 210 and node 6 260 as lower nodes.

As described above, each node succeeds to a rank of its upper node, and when lower nodes are more linked to the upper node, the lower node's succession to the rank of the upper node becomes smaller. For example, ranks of node 1 210 and node 3 230 may be calculated by the following Equations 5 and 6, respectively.

R(1)=R(2)+R(3)/2 [Equation 5]

R(3)=R(4)+R(5) [Equation 6]

In generalization, the ranks of the nodes may be calculated by an iterative algorithm as the following Equation 7.

$$R ( v ) ← {\sum }_{w ∈ uppernode [ v ]}^{ } \frac{R ( w )}{CH ( w )} \qquad [ Equation 7 ]$$

where, CH(w) represents the number of lower nodes that link to node w.

The above page rank analysis method is drawn under an assumption that a site linked by a site with a high rank is a good site, and has a structure where a lower node succeeds to a page rank of an upper node. Accordingly, as described above, the more child nodes the upper node has, the less succession the lower node has.

However, since the Kleinberg link analysis method and the page rank analysis method calculate authority and hubness of nodes by accumulating and filtering data on the nodes, as described above, it has a problem of impossibility of accurate evaluation on new contents (i.e., nodes or information).

For example, when the Kleinberg link analysis method and the page rank analysis method are applied to a vast amount of new information that web sites produce in real time every day, it is nearly impossible to perform an iterative operation for the new information through data accumulation.

Accordingly, there are many problems in applying the Kleinberg link analysis method and the page rank analysis method, which are more or less effective for evaluation on important web sites, to evaluation on news, replies or a vast of individual information produced in real time.

### DISCLOSURE OF INVENTION

### Technical Problem

It is therefore an object of the present invention to provide a method for evaluating an object based on a relation among links in an information network having multiple links, which is capable of evaluating importance of an object according to priorities of upper level links connected to a particular lower level link.

It is another object of the present invention to provide a method for evaluating an object based on a relation among links in an information network having multiple links, which is capable of efficiently and lastingly evaluating information on a new object updated in real time according to a dynamic evaluation method.

### Technical Solution

To achieve the above objects, according to an aspect, the present invention provides a method for evaluating an object based on a relation among links in an information network forming multiple links by linking one or more upper nodes to a lower node, wherein importance information link indexes of the one or more upper nodes are determined according to upper nodes that are different from the one or more upper nodes and link to the lower node later than the one or more upper nodes.

Preferably, importance information link indexes of the one or more upper nodes are determined according to the number of upper nodes that are different from the one or more upper nodes and link to the lower node later than the one or more upper nodes.

Preferably, importance information link indexes of the one or more upper nodes are determined according to importance information link indexes of upper nodes that are different from the one or more upper nodes and link to the lower node later than the one or more upper nodes.

Preferably, importance level of the lower node is determined according to importance information link indexes of the one or more upper nodes that link to the lower node.

Preferably, the lower node is news article information on a web site.

Preferably, the one or more upper nodes are information of recommendation or reply to the news article information.

Preferably, importance information link indexes of the one or more upper nodes are calculated as an average of importance information link indexes calculated for a plurality of lower nodes.

The present invention suggests a link analysis method for efficiently and lastingly evaluating information on new objects, such as news or replies, updated in real time according to a dynamic evaluation method. In addition, still with authority and hubness used the Kleinberg link analysis method, the present invention defines and uses a new calculation method to allow authority and hubness to be applied to objects requiring a real-time evaluation.

For example, when real-time linking and evaluation are performed for particular news and replies, if a particular node has a high rank at which the node links to an object with high importance, high hubness is granted to the node. This allows the object to be efficiently evaluated in real time.

In this time, higher hubness provides nodes with higher discrimination capability for good objects (for example, articles or replies). In addition, when a node is linked by many nodes with high hubness, it has high authority and is then evaluated to be a good object.

### DESCRIPTION OF DRAWINGS

FIG. 1 is a view illustrating concept of a conventional Kleinberg link analysis method;

FIG. 2 is a view illustrating concept of a conventional rank link analysis method;

FIG. 3 is a view illustrating concept of a news rank analysis method based on a link relation according to an embodiment of the present invention;

FIG. 4 is a view illustrating a hubness calculating method according to an embodiment of the present invention; and

FIG. 5 is a view illustrating an authority calculating method according to an embodiment of the present invention.

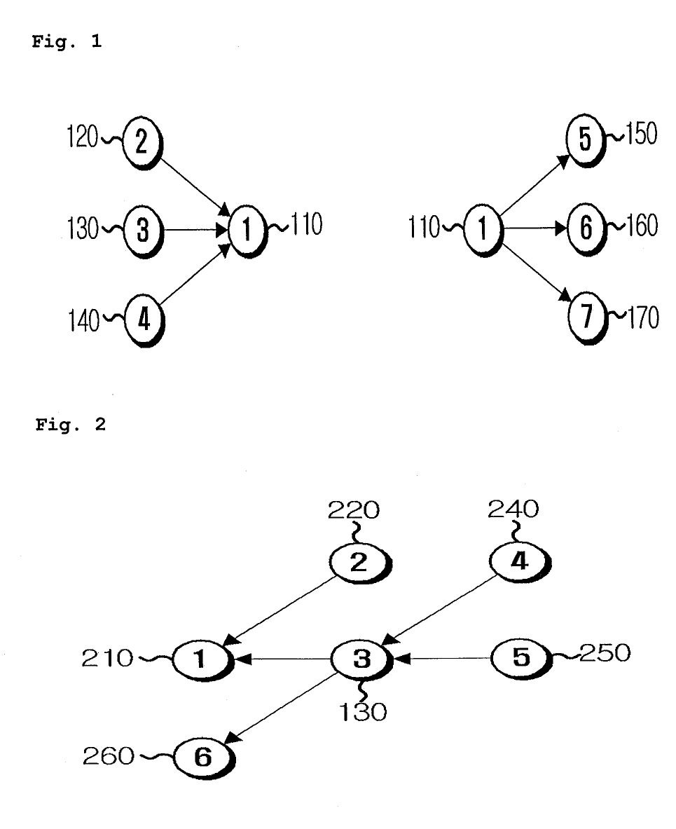

### MODE FOR INVENTION

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

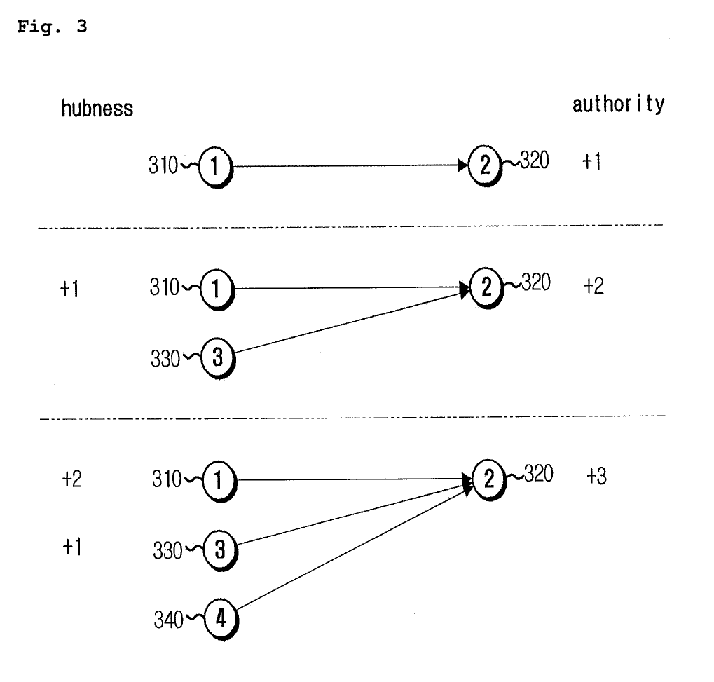

FIG. 3 is a view illustrating concept of a news rank analysis method based on a link relation according to an embodiment of the present invention.

In the present invention, whenever an upper node is additionally linked to a lower node, upper nodes that have been previously linked are calculated again. According to this, authority of the lower node is calculated again. Accordingly, an object to be evaluated is added in real time, and it becomes possible to efficiently evaluate the object according to a relation among links in an information network requiring real time evaluation on the object.

Referring to FIG. 3, first, node 1 310 links to node 2 320, then, node 3 330 links to node 2 320, and lastly, node 4 340 links to node 2 320. Of course, it is obvious that other nodes can link to node 2 320 subsequently.

In this embodiment, when node 1 310 first links to node 2 320, node 1 310 has hubness of 0 or hubness that has been previously acquired, according to a predetermined implementation method. It is assumed in the following description that hubness of the first linked upper node is 0.

Then, when node 3 320 links to the same node, i.e., node 2 320, hubness of node 1 310 that first links to node 2 320 increases by 1. At this time, hubness of node 3 320 for node 2 320 becomes 0.

Next, when node 4 320 links to node 2 320, hubness of all of the previously linked upper nodes (i.e., node 1 310 and node 3 330) increase by 1. Accordingly, hubness of node 1 310 becomes 2, hubness of node 3 330 becomes 1, and hubness of node 4 340 becomes 0.

On the other hand, if previously acquired hubness of a particular upper node is applied to the particular upper node and when upper nodes continue to be added to the same lower node, hubness of the upper nodes additionally linked to the same lower node continues to be added to hubness of an upper node first linked according to the above-mentioned method.

For example, in FIG. 3, assuming that hubness of node 1 310 is 3.2, hubness of node 3 330 is 4.1, and hubness of node 4 340 is 1.5, hubness of node 1 310 is 3.2 with no change when node 1 310 first links to node 2 320. Then, when node 3 330 additionally links to node 2 330, hubness of node 1 310 becomes 7.3 (=3.2+4.1) by adding hubness of node 3 330. Similarly, when node 4 340 additionally links to node 2 330, hubness of node 1 310 becomes 8.8 (=3.2+4.1+1.5) by adding hubness of node 3 330 and hubness of node 4 340. In addition, hubness of node 3 330 becomes 5.6 (=4.1+1.5) by adding node 4 340 linked next.

According to both of the two above-described methods, an upper node that links to the same lower node earlier has higher hubness. In addition, as the number of upper nodes that link to the same lower node later than a particular upper node increases, hubness of the particular upper node continues to increase.

This may be expressed by the following Equations 8 and 9.

H(1)=H(1)+H(3)+H(4) [Equation 8]

H(3)=H(3)+H(4) [Equation 9]

That is, the earlier an upper node links to the same lower node, the higher hubness the upper node has. In addition, as the number of upper nodes that link to the same lower node subsequently increases, hubness of an upper node that links to the same upper node earlier continues to increase.

On the other hand, authority of a lower node is calculated as the sum of hubness of upper nodes that link to the lower node as in the conventional methods. Accordingly, authority of node 2 may be obtained as the sum of upper nodes (that is, node 1 310, node 3 330 and node 4 330) that link to node 2. This may be expressed by the following Equation 10.

A(2)=H(1)+H(3)+H(4) [Equation 10]

In Equation 10, A( ) represents authority of a node and H( ) represents hubness of the node as described above.

Accordingly, as authority of a lower node becomes high, evaluation on an object become high. For example, if the lower node is news, when the news is recommended by good hubs (that is, upper nodes), the news becomes a good news. That is, a lower node that is more frequently linked by upper nodes with high hubness has higher authority, with the lower node (for example, news) evaluated as better news.

On the other hand, unlike the conventional methods, since hubness of upper nodes is not calculated by authority of a lower node, but is determined according to an order at which the upper nodes link to the same lower node, a complex iterative operation for finding a convergence value in calculating hubness and authority as in the conventional methods is not required. In addition, whenever a plurality of upper nodes link to a newly generated lower node, hubness and authority of the plurality of upper nodes and the new lower node can be easily calculated.

For example, assuming that the lower node is a newly registered news and links of the upper nodes are replies or recommendations to the news, a user who first recommends a good article has the highest hubness. In addition, when an article receives more replies or recommendations from users who have high hubness, the article has higher authority.

In this way, when the link analysis method of the present invention is applied to a news system, hubness means evaluation capability for good news articles, and, when an article recommended by a particular user receives more recommendations from other users later, the particular user who first recommended the article has capability as a better hub. That is, a hub that first recommends a good article has highest hubness.

In addition, authority means capability to produce good news, and, when news receives more recommendations from users who have high hubness, the news has higher authority.

Similarly, in addition to evaluation on the news, this may be true of evaluation on replies to the news. That is, when news has more good replies that recommend a particular reply, the news has higher authority.

However, the conventional link analysis methods may be suitable for decision of a global order for the overall webs, but not suitable for a single entity such as the new information. Accordingly, it can be said that a dynamic evaluation system as the link analysis method of the present invention is effective for new communications.

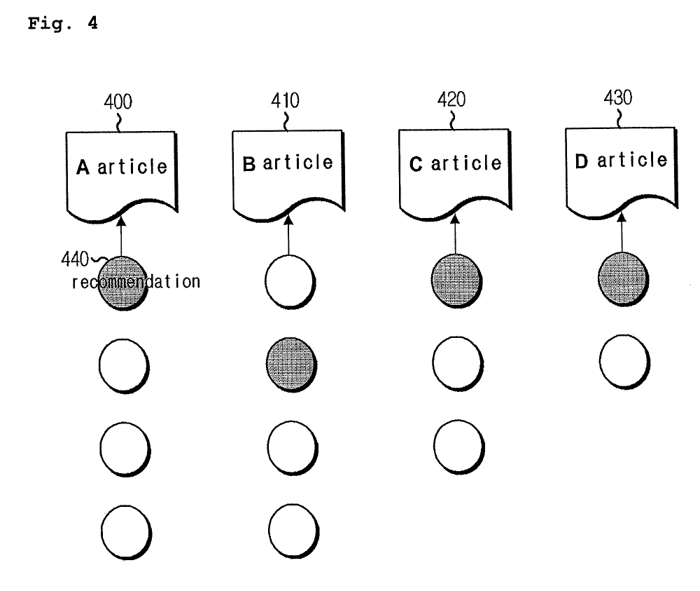

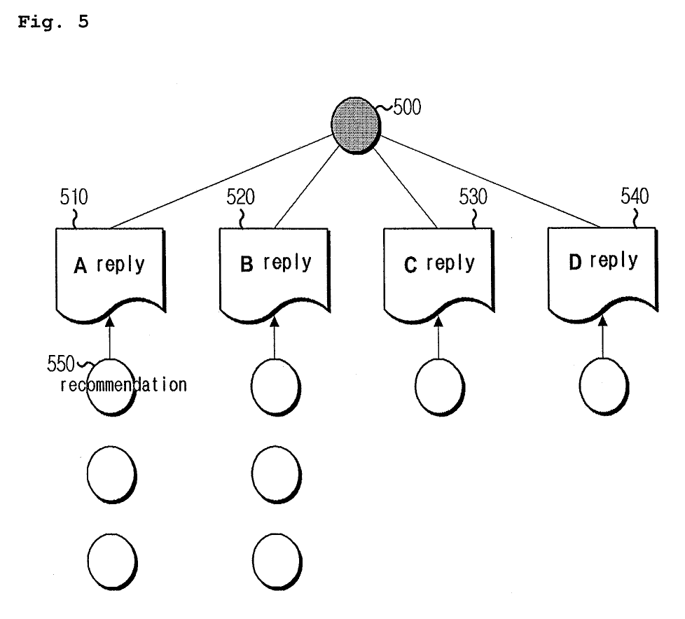

Hereinafter, a preferred embodiment to which hubness and authority calculated according to the present invention are applied will be described with reference to FIGS. 4 and 5.

FIG. 4 is a view illustrating a hubness calculating method according to an embodiment of the present invention.

Referring to FIG. 4, in calculating hubness according to the present invention as described above, different weights may be given to hubness according to a link generation order as well as a static link structure.

For example, as shown in FIG. 4, assuming that a particular user links to an A news article 400 first, a B article 410 second, and C and D articles 420 and 430 first through a recommendation or reply, hubness depends on the number of later links to the articles, according to the above-described method of the present invention.

For example, a particular user (depicted in a shade) has hubness of 3 for the A article 400 since the number of later links to the A article 400 is 3, hubness of 2 for each of the B and C articles 410 and 420 since the number of later links to each of the B and C articles 410 and 420 is 3, and hubness of 1 for the D article 430 since the number of later links to the D article 430 is 1.

In the end, hubness of the particular user may be represented as average of hubnesses evaluated for these articles. That is, hubness of the particular user may be expressed by the following Equation 11.

Hubness=Average{3,2,2,1}=2 [Equation 11]

As hubness expressed by Equation 11 increases, the increasing hubness is applied at any later recommendations, and thus, an effect of the particular user on other users increases.

As can be seen from the above description, since a better article has the more number of relies or recommendations, a user has high hubness when preferential recommendations or replies for a good article are made. On the contrary, a bad article has less recommendations or replies. Accordingly, although senseless recommendations for the bad article are preferentially made, since there are little users who add recommendations or replies to the bad article, hubness of the bad article becomes lowered.

Accordingly, the link evaluation method of the present invention allows good articles to be evaluated reasonably. In other words, a good article with higher evaluation has higher hubness, resulting in high reliability of the good article.

FIG. 5 is a view illustrating an authority calculating method according to an embodiment of the present invention.

Referring to FIG. 5, as described above, in calculating authority according to the present invention, the more the linked upper nodes, the higher authority the lower node has, resulting in higher importance of the lower node.

For example, authority for a particular article 500 may be calculated by the number of links of replies linked to the article 500 (i.e., the number of recommendations) For example, assuming that an A reply 510 has three recommendations 550, a B reply 520 has three recommendations, a C reply 530 has one recommendation, and a D reply 540 has one recommendation, authority for the article 500 may be calculated as an average of number of recommendations to each of the replies.

Accordingly, authority for the article may be expressed by the following Equation 12.

Authority=Average{3,3,1,1}=2 [Equation 12]

When authority in Equation 12 increases, a degree of disclosure of the article may increase according to application of authority. In other words, since importance of the article may be determined depending on the number of recommendations or replies of users, if the article is an article with high authority calculated according to the present invention, the degree of disclosure of the article may be varied according to an order of authority.

As described above, when values of nodes are evaluated according to the link relation, by reflecting a link order of upper nodes on importance of a lower node, unlike the conventional link analysis methods, fast and precise evaluation of users for real time-increasing objects such as news becomes possible.

Moreover, when the above-described evaluation method is applied to web sites and the like, an editor function may be granted to users with high hubness and a pressman function may be granted to users with high authority.

### INDUSTRIAL AVAILABILITY

According to the present invention, since hubness and authority of upper nodes and lower nodes are re-calculated in consideration of a link order whenever an upper node additionally links to a lower node, it is possible to efficiently evaluate newly added objects in real time based on a link relation among the objects in an information network.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. In an information network forming multiple links by linking one or more upper nodes to a lower node, a method for evaluating an object based on a relation among links, wherein importance information link indexes of the one or more upper nodes are determined according to upper nodes that are different from the one or more upper nodes and link to the lower node later than the one or more upper nodes.

2. The method according to claim 1, wherein importance information link indexes of the one or more upper nodes are determined according to the number of upper nodes that are different from the one or more upper nodes and link to the lower node later than the one or more upper nodes.

3. The method according to claim 1, wherein importance information link indexes of the one or more upper nodes are determined according to importance information link indexes of upper nodes that are different from the one or more upper nodes and link to the lower node later than the one or more upper nodes.

4. The method according to claim 1, wherein importance level of the lower node is determined according to importance information link indexes of the one or more upper nodes that link to the lower node.

5. The method according to claim 1, wherein the lower node is news article information on a web site.

6. The method according to claim 4, wherein the one or more upper nodes are information of recommendation to the news article information.

7. The method according to claim 4, wherein the one or more upper nodes are information of reply to the news article information.

8. The method according to claim 1, wherein importance information link indexes of the one or more upper nodes are calculated as an average of importance information link indexes calculated for a plurality of lower nodes.
